(19) United States
(12) Patent Application Publication
(10) Pub. No.: US 2013/0097220 A1
(43) Pub. Date: Apr. 18, 2013

(54) STREAMING BITRATE CONTROL AND MANAGEMENT

(71) Applicants: Martin S. Lyons, Hendereson, NV (US); Joseph Lerner, Reno, NV (US)

(72) Inventors: Martin S. Lyons, Hendereson, NV (US); Joseph Lerner, Reno, NV (US)

(73) Assignee: BALLY GAMING, INC., Las Vegas, NV (US)

(21) Appl. No.: 13/273,555

(22) Filed: Oct. 14, 2011

(51) Int. Cl. G06F 15/16

(52) U.S. Cl. 709/203

(57) ABSTRACT

A bitrate control and management system enables control of the compression module. In one embodiment, the system comprises a server in communication with a client device over a network. The server includes a processor and a compression module. The processor outputs data and one or more bitrate control commands to the compression module. The compression module encodes the data received from the processor according to the one or more bitrate control commands. In one embodiment, the data output by the processor may be rendered by another processor prior to being received by the compression module. Once encoded, the data is sent to the client device over the network. The client device includes a decompression module that receives and decodes the data received from the server. The client device may include a display and a video encoder that encodes the decoded data into a display signal compatible with the display.

### CROSS-REFERENCE TO RELATED APPLICATIONS

This application is related to co-pending U.S. patent application Ser. No. ______, filed on ______.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This description relates to streaming and compressing data.

### BACKGROUND

Prior to the advent of streaming technology, data such as multimedia data was conventionally transferred from a server to a client device in its entirety over a computer network, prior to the data being presented to the client device. Streaming data enables data to be presented to the user of the client device while the client device receives data from the server. Streaming data from servers to client devices over a network is typically limited by the bandwidth of the network, or alternatively, the physical layer net bitrate. As technology has progressed, the bandwidth available to both servers and client devices has increased.

Traditional streaming protocols, such as RTSP (Real-Time Streaming Protocol), MS-WMSP (Windows Media HTTP Streaming Protocol), and RTMP (Real Time Messaging Protocol); essentially send data in small packets from the server to the client device in real-time at the encoded bitrate of the data. Packets can range in size depending on the implemented protocol; for example, packets sent using RTSP typically consist of 1452 bytes, which translates to about 11 milliseconds of video per packet for a video having an encoded bitrate of 1 Mbit/s. Additionally, the client device only receives enough packets to fill a buffer, which is typically around five seconds with respect to streaming video. Thus, if a user pauses a video for an hour on the client device, the buffer becomes saturated with only the next five seconds notwithstanding the fact that an hour has elapsed. Notably, traditional streaming protocols transmit at the encoded bitrate of the data irrespective of bandwidth availability.

In contrast, adaptive streaming, as implemented, almost exclusively relies on HTTP for the transport protocol. Similar to traditional streaming, data is encoded into discrete packets of a particular size; however, the source data is encoded at multiple bitrates rather than a single bitrate. The data packets corresponding to the same data encoded at different bitrates are then indexed based on the bitrate in memory. This streaming method works by measuring, in real-time, the available bandwidth and computer capacity of the client device, and adjusts which indexed data packet to transfer based on the encoded bitrate. For example, a video may be encoded at a high, medium, and low bitrate; each respectively having a high, medium, and low quality. Depending on the availability of bandwidth and computer capacity, adaptive streaming automatically switches between the high, medium, and low bitrate indexed data packets for the client device to provide a seamless video experience. While adaptive streaming may measure available bandwidth and computer capacity in real-time, the data packets are not encoded in real-time. As such, valuable resources, such as memory, are rapidly consumed as a result of storing and indexing each data packet at multiple bitrates.

In conjunction with technologies allowing for greater bandwidth, industry has also developed a variety of different encoders and decoders (codecs) to reduce the bitrate prior to transmission of data over a network. Encoding itself is an art, in that too much compression may lead to observable compression artifacts upon decompression. Such observable artifacts typically distort the image in an undesirable way. For example, decompressing a compressed video may result in pixilation. More compression necessarily results in a lower requisite bitrate for transfer but yields lower quality upon decompression, whereas less compression results in a higher requisite bitrate but yields higher quality upon decompression.

Despite notable improvement in available bandwidth, streaming protocol, and codec technology, available bandwidth remains a limitation. Thus, available bandwidth is a valuable resource in the field of data transmission. Though the above implementation of adaptive streaming is reactive to changes in available bandwidth and computer capacity, it only measures available bandwidth and adjusts accordingly. Nor is the above implementation of adaptive streaming friendly to memory resources because each file is encoded at different bitrates and indexed accordingly rather than encode in real-time based on the needs of the client device. Moreover, adaptive streaming is limited to the bitrates at which the streamed data was previously encoded and indexed. Thus, industry as a whole stands to benefit from any improvement optimizing the amount of bandwidth required to stream real-time data over a network. Specifically, the casino industry making use of electronic gaming machines (EGMs) controlled by game software.

In the past, a computer local to each EGM hosted the game software (e.g. a video spinning reel game), which generated graphical primitives that were communicated to a graphics processor (GPU) and connected to one or more LCD displays of that particular EGM. The graphical primitives typically comprise various types of data such as textures, coordinates, and other metadata. Graphical primitives of a particular size are often cached in the GPU video memory to avoid saturating the data bus between the computer hosting the game software and the GPU. Upon receiving graphical primitives, the GPU renders them into a frame buffer of a particular format in the GPU video memory. Once the frame buffer has been rendered, a video encoder encodes the rendered frame into a display signal, such as DisplayPort, VGA, DVI, or HDMI, that is sent to the LCD display for viewing. EGMs with multiple LCD displays use the same, but parallel, configuration for each LCD display.

More recently, an approach allowing the game software to be hosted by a computer remote from the EGM has surfaced. Such an approach utilizes a compression module using a codec such as H.264 to compress the rendered frame stored in the GPU video memory rather than send the rendered frame directly to the LCD display. The compressed rendered frame is then sent over an Ethernet interface via TCP/IP to the EGM. At the EGM, the compressed rendered frame is decompressed into a frame buffer of a GPU video memory local to the EGM and transmitted to the LCD display as before. As previously described, this process is run in parallel for each LCD in an EGM with multiple LCD displays.

Since each display of an EGM takes up precious bandwidth in the streaming process, the number of EGMs that can be supported by a single server is directly dependent on the bandwidth consumed by each display. Thus, it is desirable to lower the average bandwidth required to stream real-time data over a network. Accordingly, there continues to be a need for improvements in the area of data transfer.

### SUMMARY

Briefly, and in general terms, various embodiments are directed to a system and method for managing the compression technique employed by a compression module to control the consumption of bandwidth and improve the performance of the compression module.

In some embodiments, a streaming bitrate control and management system includes a server that is in communication with a client device over a communication network having a bandwidth. The server may include software, a processor, a compression module, and a network interface. The compression module may receive data from the processor and compress it according to one or more bitrate control commands. Following compression, the data may be sent to a network interface for transmission over the communication network to the client device.

In some embodiments, the client device, which is bound to receive the compressed data, may include a network interface, a decompression module, and a speaker. The decompression module may decompress the data received from the server. The decompressed data may then be sent to a presentation module, such as a speaker, for presentation to the user. In some embodiments, the client device includes one or more user input devices configured to generate user input data. Upon generation, user input data may be transmitted to the server. In some embodiments, the client device includes a display for displaying graphical data.

In some embodiments, a streaming bitrate control and management system includes a server that is in communication with a client device over a communication network having a bandwidth. The server may include software, a graphics processor, a video memory associated with the graphics processor, a compression module, and a network interface. The graphics processor may receive graphical data generated by the software. Upon receiving graphical data, the graphics processor may render the data into a frame buffer and store the rendered frame buffer in the video memory. The compression module may receive the frame buffer, and compress it according to one or more bitrate control commands received from the software. Following compression, the data may be sent to a network interface for transmission over the communication network to the client device.

In some embodiments, the client device, which is bound to receive the compressed data, may include a network interface, a decompression module, a video memory, a video encoder, and a display. The decompression module may decompress the data received from the server into a frame buffer. The frame buffer may be stored in the video memory on the client device. The encoder may encode the frame buffer into a display signal that is compatible with the display. In some embodiments, the client device includes one or more user input devices configured to generate user input data. Upon generation, user input data may be transmitted to the server. In some embodiments, the client device includes a speaker for playing audio data.

In some embodiments, the processor on the server may perform a motion compensation process for the compression module to reduce the workload of the compression module and increase the availability of the bandwidth associated with the communication network. In such embodiments, the processor may output motion compensation data to the compression module.

In some embodiments, the server includes an instruction management module that may adjust one or more instructions associated with the one or more bitrate control commands based on one or more management criteria. In one embodiment, the instruction management module may adjust the bitrate requests by altering the one or more bitrate control commands received from the software. In another embodiment, the instruction management module may adjust the bitrate requests by generating a new one or more bitrate control commands in place of the unaltered one or more bitrate control commands received from the software.

In some embodiments, the software hosted by the server may not generate bitrate control commands. In such embodiments, the instruction management module may be used to interface with, for example, one or more user input devices on the client device. Otherwise stated, the instruction management module may be configured to receive user input data generated by one or more user input devices. In such embodiments, the instruction management module may generate and send one or more bitrate control commands to the compression module.

In some embodiments, the instruction management module may receive data indicative of quality from the compression module. Utilizing the data in a feedback loop, the instruction management module may use this information to adjust the one or more data compression settings of the compression module until an acceptable error rate, i.e., quality, is achieved. In some embodiments, the compression module calculates the error rate based on the peak signal-to-noise ratio.

The foregoing summary does not encompass the claimed invention in its entirety, nor are the embodiments intended to be limiting. Rather, the embodiments are provided as mere examples.

### BRIEF DESCRIPTION OF THE DRAWING

FIG. 1 is a block diagram illustrating an embodiment of a streaming bitrate control and management system.

FIG. 2 is a block diagram illustrating an embodiment of a streaming bitrate control and management system including a game server and an EGM.

FIG. 3 is a logic flow diagram depicting a process for controlling the compression bitrate of the data sent to an EGM.

FIG. 4 is a logic flow diagram depicting a process for controlling the compression bitrate of data sent to a client device from a game server hosting a game that seemingly lacks cyclical qualities.

FIG. 5 is a block diagram illustrating an embodiment of a streaming bitrate control and management system that may transmit graphical data, audio data, or combinations thereof.

FIG. 6 illustrates one embodiment involving a server and a vehicle.

FIG. 7A is a logic flow diagram depicting a process for reducing the consumption of bandwidth and the workload of a compression module.

FIG. 7B illustrates one embodiment of a frame divided into macro-blocks subjected to the process depicted in FIG. 7A.

FIG. 7C illustrates one embodiment of a frame divided into macro-blocks subjected to the process depicted in FIG. 7A.

FIG. 8 is a block diagram illustrating an embodiment of a streaming bitrate control and management system including a game server, an EGM, and an instruction management module.

FIG. 9 is a logic flow diagram depicting a metering/monitoring process for determining the average bitrate requested by one or more EGMs.

### DETAILED DESCRIPTION

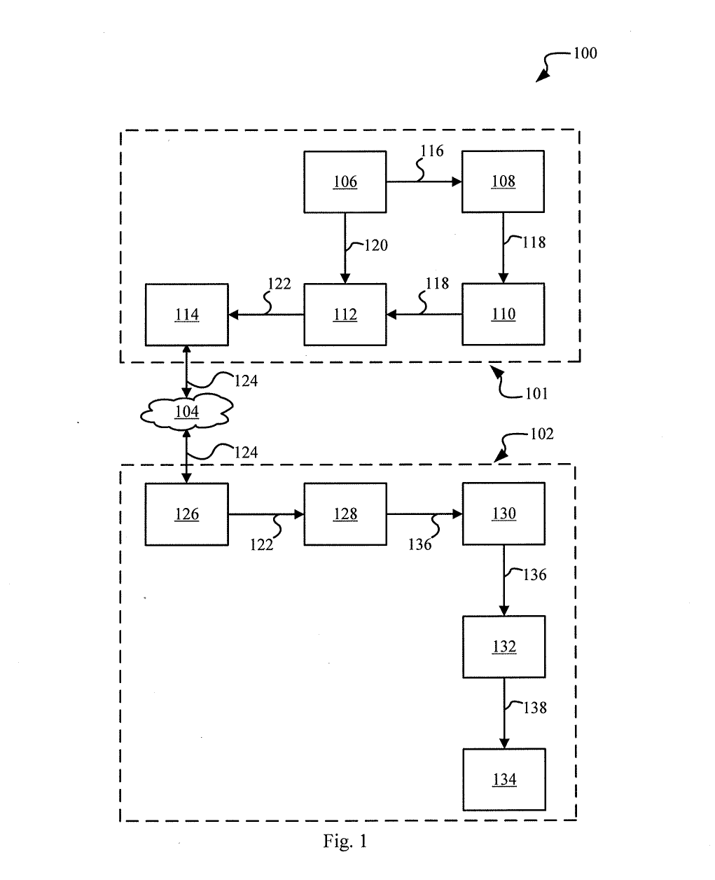

Referring now to the drawings, wherein like reference numerals denote like or corresponding parts throughout the drawings and, more particularly to FIGS. 1-9, there are shown various embodiments of systems and methods for optimizing the amount of bandwidth consumed in streaming data over a communication network from a server to a client device.

More specifically, FIG. 1 is a block diagram illustrating an embodiment of a streaming bitrate control and management system 100. The streaming bitrate control and management system 100 includes a server 101 that is in communication with a client device 102 over a communication network 104 having a bandwidth. Server 101 includes software 106, a graphics processor 108, a video memory 110 associated with the graphics processor, a compression module 112, and a network interface 114. The graphics processor 108 receives graphical data 116 generated by software 106. Upon receiving graphical data 116, graphics processor 108 renders the data into a frame buffer 118 of a particular format and stores the rendered frame buffer in the video memory 110. The compression module 112 then receives the frame buffer 118 for compression, and compresses the frame buffer according to one or more bitrate control commands 120 received from the software 106. Once the frame buffer 118 is compressed according to the one or more bitrate control commands 120, the compression module 112 transmits the compressed data 122 to a network interface 114 for transmission via transport protocol 124 over the communication network 104 to the client device 102.

The client device 102, which is bound to receive compressed data 122, includes a network interface 126, a decompression module 128, a video memory 130, a video encoder 132, and a display 134. Upon receiving the compressed data 122 sent from the server 101 over the communication network 104, the decompression module 128 decompresses the data into a decompressed frame buffer 136 and is stored in the video memory 130. The encoder 132 then encodes the decompressed frame buffer 136 into a display signal 138 that is compatible with display 134 for viewing. Those of ordinary skill in the art will appreciate that this disclosure relates to wired communication systems as well as wireless communication systems.

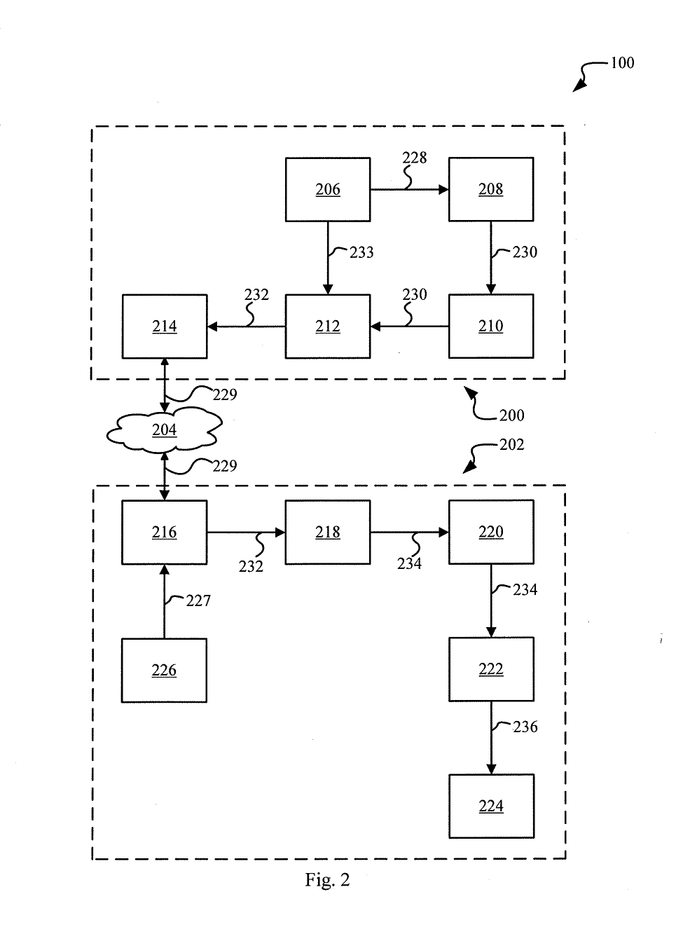

FIG. 2 is a block diagram illustrating an embodiment of a streaming bitrate control and management system including a game server and an EGM. In this embodiment, the streaming bitrate control and management system 100 includes a game server generally shown as 200 that is in communication with a client device 202, depicted in this embodiment as an EGM, over a communication network 204. The communication network 204 may be wired or wireless. The game server 200 hosts the game software 206 such that the EGM 202 requires less computing power than would otherwise be necessary because the server is processing and rendering the graphics prior. The game software 206 may be of any type, for example and without limitation, card games; dice games; random number games such as Bingo, Keno, and Roulette; slot machine games; and any other game requiring user involvement. Additionally, the game server 200 may support more than one EGM in other embodiments. The game server 200 further includes a graphics processor 208, a video memory 210, a compression module 212, and a network interface 214. Somewhat similar, the EGM 202 includes a network interface 216, a decompression module 218, a video memory 220, a video encoder 222, a display 224, and one or more user input devices 226. The one or more user input devices 226 may be of any type but electromechanical and electrical are preferable; for example and without limitation, touch sensing technology using resistive, infrared, optical, acoustic, mechanical, or capacitive technologies; switches; buttons, and other input means adaptable to convey a message from the user to the server 200, EGM 202, or combinations thereof. EGM 202 may also generate signals based on inputs irrespective of the user, e.g., the EGM may have at least one transducer or the like to send data relating to lighting, sound, or temperature conditions surrounding the EGM 202 to the game server 200.

Either autonomously or based on the one or more user inputs 226, the game software 206 generates graphical data 228, which in turn is received by the graphics processor 208 for rendering. Those of ordinary skill in the art will appreciate that the one or more user input devices 226 will generate user input data 227 that may then be transmitted to the game server 200 for analysis by the game software 206. In such a case, the user input data 227 or data that is otherwise generated by the EGM 202 may be sent to the network interface 228 for transmission via a transport protocol 229 over the communication network 204 to the game server 200. Other embodiments send the data from the EGM 202 to the server 200 over a communication network different from that of the communication network 204 utilizing protocol such as Game to System (G2S). Autonomous generation of graphical data 228 may occur, for example, where the EGM has failed to send an input to the game server 200 over a static or dynamic period of time. Generation of graphics in such a way enables the EGM 202 to generate excitement in an inactive user or passer-by by stimulating the senses of the human body, usually both visually and audibly.

Other embodiments stimulate the human body by emitting a particular scent or aroma over a fixed or dynamic period of time, or even based on user input. In such embodiments, undesired odors such as smoke may be masked. Autonomous generation of graphics may also occur for a display unit that operates irrespective of any user input device, for example, a title display associated with the EGM. In one embodiment, an EGM has an Avalanche Theme, which has a title display playing various avalanche videos over a period of time. In another embodiment, an EGM has a Tornado Theme, which has a title display playing various tornado videos. Both of these themes may additionally be based on user input or user performance in the game; for example, the avalanche or tornado videos may become more severe to generate excitement as the user wins more and more.

Upon receiving the graphical data 228 generated by game software 206, game processor 208 renders the data into a frame buffer 230 of a particular format and stores the rendered frame buffer in the video memory 210 associated with the graphics processor 208. The format of frame buffer 230 may vary, but it typically includes, by way of example, raw pixel information corresponding to red, green, blue, and transparency values. Following storage in the video memory 210, the compression module 212 thereafter receives the frame buffer 230 for compression, and compresses the frame buffer according to one or more bitrate control commands 233 received from the game software 206. The one or more bitrate control commands 233 may be based on one or more request criteria including, for example, the state of the game. In one embodiment, the H.264 standard is used for compression and decompression, which may be implemented through use of Cavium Networks hardware. However, other codec standards, hardware, and hardware configurations may also be used in accordance with other embodiments.

Once the frame buffer 230 is compressed according to the one or more bitrate control commands 233, the network interface 214 receives the frame buffer from the compression module 212 for transmission via transport protocol 229 over the communication network 204 to the EGM 202. In one embodiment, the communication network 204 follows Ethernet protocol, and the transport protocol 229 is TCP/IP for the delivery of the compressed frame buffer 232 over the communication network 204 to the EGM 202. However, in other embodiments, the communication network 204 and transport protocol 229 may differ based on a variety of factors such as cost and ease of implementation.

The EGM 202 in turn receives the compressed frame buffer 232 from the game server 200. The decompression module 218 receives the compressed frame buffer 232 from the network interface 216 and decompresses it into decompressed frame buffer 234, which is then stored in the video memory 220. Those of ordinary skill in the art will appreciate that the decompressed frame buffer 234 will be similar to but not exactly the same as the original due to the nature of lossy compression. Other embodiments of the bitrate control and management system 100 employ lossless compression. However, those embodiments are left with fewer bitrate choices depending on the application and content involved.

Following storage in the video memory 220, the video encoder 222 encodes the decompressed frame buffer 234 into a display signal 236 that is compatible with the display 224 for viewing. In one embodiment, the display signal 236 is DisplayPort. However, other video signals are used by the bitrate control and management system 100, such as VGA, DVI, and HDMI. In one embodiment, the display 224 is an LCD display. In another embodiment, the display 224 is an LCD display implementing touch screen technology. In yet other embodiments, other types of displays may be used.

Since bandwidth is a limited resource, it is desirable to control the amount of bandwidth used by the EGM 202 without jeopardizing the quality of play for the user. As previously indicated, FIG. 2 shows a single EGM with a single display. However, in other embodiments, a single game server 200 supports a single EGM with more than one display, as well as more than one EGM each with one or more displays. As the number of displays associated with a single EGM increases or the number of EGMs having one or more displays connected to the communication network 204 increases, the net bitrate consumption increases as a result of the game server 200 having to support more than display in the aggregate. In the embodiment of FIG. 2, the one or more bitrate control signals 233 sent to the compression module 212 from the game software 206 reduces the amount of bandwidth by controlling the bitrate at which the frame buffer 230 is compressed according to the one or more request criteria including, for example, the state of the game hosted by the server 200. In one embodiment, the one or more bitrate control commands 233 may lower or raise the bitrate, but have an overall effect of reducing bandwidth.

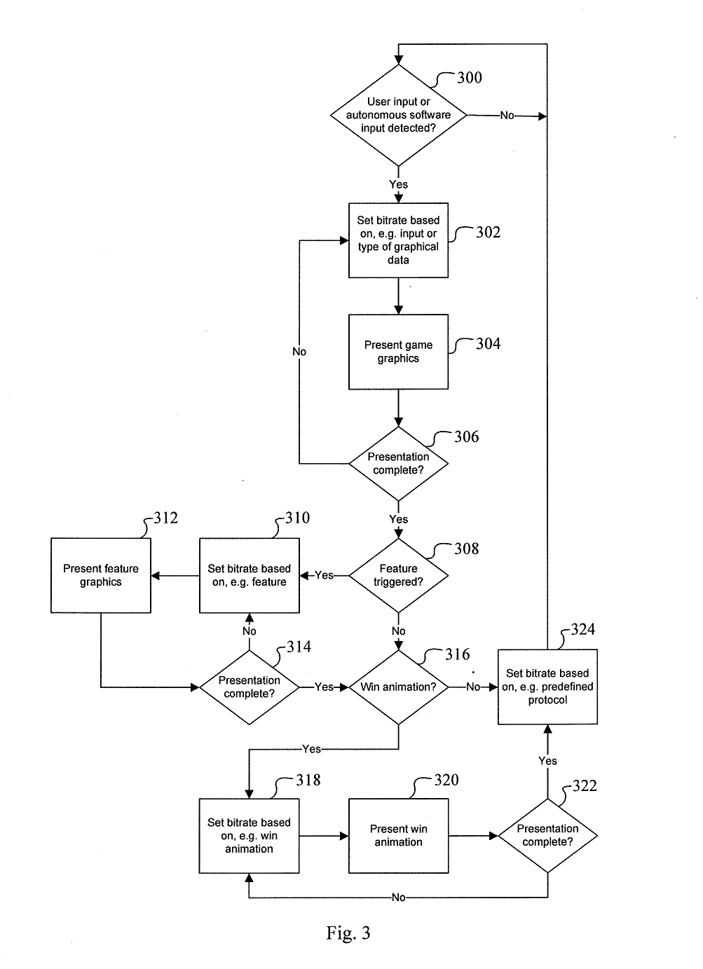

FIG. 3 is a logic flow diagram depicting one embodiment of a process for controlling the compression bitrate of the data sent to an EGM, such as the one depicted in FIG. 2. The process depicted in FIG. 3 may be applied to other EGMs and applications in the gaming industry, and even applications outside the gaming industry. FIG. 3 more notably unveils a process for controlling the consumption of bandwidth via one or more bitrate control commands communicated from software to an encoder. Accordingly, FIG. 3 is intended to be a non-limiting, specific embodiment of the disclosed system.

At block 300, an EGM determines whether a user input or an autonomous software input has been detected. If neither is detected, the game software waits until such an input is detected. Otherwise, the compression module is, in one embodiment, set to encode at a predetermined or default bitrate until the game software provides instruction to decrease or increase the bitrate via one or more bitrate control commands. Once either input is detected, block 302 sets one or more data compression settings, such as bitrate, of the compression module according to the one or more request criteria including, for example, input or type of graphical data. Otherwise stated, the game software sends one or more bitrate control commands to the compression module with instruction to compress data in view of the type of input data generated (user or software) or the type of graphical data destined for display to the user. The type of graphical data may, in some embodiments, relate to the game state of the EGM. For example, an EGM may include a gambling sequence such as the spinning of the reels on a slot machine, a win animation, and a bonus animation such as when one triggers a bonus round.

For example, where the EGM presents a slot machine style game, the one or more user input devices may include a command to spin the slot reels. In one embodiment, the game software sends one or more bitrate control commands to the compression module for a high bitrate to ensure high quality animation of the spinning reels with minimal compression artifacts. In another embodiment, the start of the spin cycle is compressed according to a low bitrate, and then compressed at a high bitrate once the first reel starts to slow. This is when compression artifacts may become more visible to the user during the spin.

In yet another embodiment, each reel of the EGM is displayed on a separate display, e.g., a five reel slot may have a separate display for each reel. As such, each reel may be independently controlled from a bitrate perspective; and accordingly, may further reduce consumption of bandwidth as described below. At the beginning of the spin cycle, the graphical reel data corresponding to each reel may be compressed according to a low bitrate. Once the first reel slows (or another triggering event occurs, such as when compression artifacts become visible), the graphical data corresponding to that reel is compressed at a higher bitrate while the data corresponding to the other reels, which are still spinning, continues to be compressed at a lower bitrate. Once the second reel slows (or another triggering event occurs), the graphical data corresponding to that reel is compressed at a higher bitrate similar to the first reel while the data corresponding to the third, fourth, and fifth reels continue to be compressed at a lower bitrate. The same approach may be applied to the third, fourth, and fifth reels until each reel has stopped. In one embodiment, the graphical data corresponding to each reel may be compressed similar to that of other embodiments described herein. For example, each reel may be fixed to compress the graphical data corresponding to the spin cycle at a high bitrate.

In another embodiment, the game software sends one or more bitrate control commands to the compression module to compress the graphical data irrespective of the input; but rather, based on the type of graphical data, for example. In such an embodiment, even though a reel spin may typically employ a high bitrate to minimize compression artifacts, the game software may analyze the graphical data destined for display. The game software may determine that the type of graphical data enables compression according to a low bitrate during the entire spin cycle due to the nature of the graphical data. For example, graphical data corresponding to complex shapes, figures, and color schemes is more likely to result in less desirable compression artifacts as compared with simple shapes, figures, and color schemes. Hash values may be used to enable the software to differentiate between simple and complex graphical elements in an expedited manner. Thus, an EGM with a Complex Art Theme having reels with square-colored icons (having a first hash value) may not employ as high of a bitrate to maintain the integrity of the square upon decompression as compared to other more complex icons (having a second hash value), such as icons depicting different complex artwork.

Continuing, in the slot machine embodiment, the one or more user input devices may cause the game software to indicate to the user the number of lines bet, or provide a visual display of the lines over the reels for the user. The one or more user input devices may also provide instructions/rules corresponding to the game, e.g., payout information. The user may even be provided with a welcome or goodbye message for inserting credits or removing credits, respectively. Such user inputs may be tied to a low bitrate command if the corresponding graphical data does not correspond to visually intense graphics. However, a visually stunning video may, for example, be displayed to the user for welcome or goodbye messages to generate excitement that may cause the game software to employ a higher bitrate to prevent undesired compression artifacts from surfacing.

In an embodiment where the EGM presents a Roulette game, a user input to spin the wheel may, without limitation, cause the game software to send one or more bitrate control commands to compress the corresponding graphical data according to a high bitrate. Other commands may cause a lower bitrate to be employed. Similar to the slot machine embodiment above, the game software may send, in one embodiment, one or more bitrate control commands to the compression module. As a result, the start of the wheel spin is compressed according to a low bitrate, and then compressed to a higher bitrate once the wheel starts to slow.

Those of ordinary skill in the art will appreciate that the above examples are not intended to limit the scope of the examples or this disclosure, and that not all examples related to EGMs have been listed for the sake of brevity. For example, the spin of the reels in a slot machine may be compressed according to one, two, three, or more bitrates.

At block 304, the graphical data is compressed according to the one or more bitrate control commands and is sent to the EGM for display and presentment to the user. It is then determined at block 306 if the presentation of the game graphics is complete; if not, block 302 is revisited. Revisiting block 302 until the presentation of the graphics is complete allows for the data to be compressed according to one or more bitrates. In one embodiment, block 306 returns to 302 because other inputs may be taken into account and reduce or increase the bitrate accordingly during the graphical presentation. For example, where the EGM presents a slot machine style game, the user may first initiate the spinning of the reels by activating a spin input. Many slot machine games also enable the user to stop the reels all at once if the spin input or another input is activated while one or more reels spin. In such an example, it may be desirable to change the bitrate from the bitrate that was previously sent to the compression module via the one or more bitrate controls to ensure that the immediate stoppage of the spinning reels is adequately presented without readily observable compression artifacts.

If it is determined at block 302 that the graphical data may be compressed according to one bitrate, block 306 may return to block 304 (graphical data is compressed according to the one or more bitrate control commands and is sent to the EGM for display and presentment to the user) instead of block 302 (sets one or more data compression settings). Notwithstanding, the graphical data may still be compressed according to more than one bitrate if block 306 returns to block 304 instead of block 302. In such an embodiment, the plurality of bitrates may be handled at the first processing of block 302. Once the software determines the number of bitrates (e.g., where the EGM presents a slot machine game and the video reels are compressed at two or more bitrates), the software sends the plurality of bitrate control signals to the compression module, which may be received in a buffer or other type of memory location.

In one embodiment, a separate control command is sent for each frame the compression module encodes. After each frame is encoded, the compression module processes the next bitrate control command to determine at which bitrate to compress the next frame. In another embodiment, each bitrate control command contains header information relating to, for example, how many frames are to be compressed based on the bitrate associated with the first processed bitrate control command until the next bitrate control command is to be processed. In yet another embodiment, each bitrate control command contains header information relating to, from a time perspective, how long each bitrate control command is to apply. For example, graphical data in the form of a five second video may be compressed pursuant to three bitrate control commands. The first bitrate control command may instruct the compression module to compress the data according to a first bitrate for three seconds. After three seconds has elapsed, the second bitrate control command may then be processed by the compression module. Upon processing the second bitrate control command, the compression module may encode the data pursuant to a second bitrate for the time period indicated in the header. Once that time has elapsed, the third bitrate control command may then be processed.

If the presentation of the game graphics is complete at block 306, it is then determined at block 308 whether a feature has been triggered if the game variant is programmed to include such an event. If the game variant is not programmed to include such an event, then block 308 proceeds to block 316 (determines whether a win animation is triggered) rather than block 310 (sets the bit rate based on the one or more request criteria) in such an embodiment. A feature may include, by way of example, a benefit to the user, e.g., a bonus round awarding a prize that enhances or is in addition to any prize, if any, from the base game. A feature may also include a stimulation of one or more senses of the user, e.g., a bonus game that causes the user to pick flowers resulting in the EGM emitting a flower aroma. For example, where the EGM presents a slot machine style game, the feature may be, without limitation, a bonus game, an interactive-user feature, or a video to generate excitement and stimulate continued play. Thus, where the sequence of five battleships in a row is required to win the jackpot and less then five in a row were obtained, a video sequence of less than five battleships being destroyed may be displayed along with a shot coming close to, but not sinking, the fifth battleship. A bonus game may be limited to a single machine or may include more than one machine working in cooperative or competitive fashion. An interactive-user feature may include, by way of example, a bonus game that causes the user to select one or more chests to open in hopes to unveil a prize.

Where the EGM presents a Roulette game, a feature may be triggered, for example, when a pre-determined number of black or red pockets have occurred in a row respective or irrespective of betting strategy. A feature may also be triggered by randomly generating one more bonus icon corresponding to one more pockets prior to every spin. If the ball lands in a pocket associated with a bonus icon, a feature may be triggered. For example, free bonus spins that take into consideration the initial bet made in the base game may be awarded to the player. Where the EGM presents a card game, a feature may be triggered, for example, when a player wins a pre-determined number of hands in a row. Those of ordinary skill in the art will appreciate that the features described herein are intended to be non-limiting specific embodiments of the disclosed system.

If a feature has been triggered, block 310 sets the bit rate based on the one or more request criteria including, for example, the feature triggered. Otherwise stated, the game software sends one or more bitrate control commands to the compression module with an instruction to compress data according to a particular data compression setting, e.g., bitrate. A more complex feature may cause a higher bitrate to be employed whereas a graphically simple feature may cause a lower bitrate to be employed. Hash values may be used to enable the software to differentiate between simple and complex graphical features in an expedited manner. Features may also be compressed, similar to the data compressed at block 302, according to more than one bitrate.

In one embodiment, the introduction of a feature may initially be presented to the user in a graphically-intense video to generate excitement. For example, in an avalanche themed slot machine, the feature may start with a catastrophic video of an avalanche. In one embodiment, the game software may send a command to the compression module to compress the graphically-intense introduction pursuant to a high bitrate. After the avalanche settles, the slot machine may cause the user to select among a variety of different ice chunks to shatter the ice around one or more treasures resulting in acquisition of one or more prizes or awards. In one embodiment, the game software may send a command to compress the graphical data corresponding to the shattering of ice chunks according to a lower bitrate. Depending on the treasure or treasures unveiled, the feature may calmly or excitedly end with the latter likely occurring when the most coveted prize is obtained by the user. In one embodiment, the game software may send a command to compress the graphical data corresponding to end the feature according to a high or low bitrate depending on the graphical intensity of the feature.

In another embodiment where the EGM presents a Roulette game, a feature may include a bonus round where one or more balls are simultaneously dropped onto the wheel while a rotating perspective view of the action is presented to the user. In such an embodiment, the game software may send a command to the compression module to compress the graphical data corresponding to the feature at one or more bitrates.

At block 312, the graphical data corresponding to the feature is compressed according to the one or more bitrate control commands and is sent to the EGM for display and presentment to the user. It is then determined at block 314 if the presentation of the feature is complete; and if not, block 310 (sets the bitrate based on the one or more request criteria) is revisited. Revisiting block 310 until the presentation of the feature is complete enables for the data to be compressed according to one or more bitrates. In one embodiment, block 314 returns to 310 because factors other than the feature, e.g., user inputs, may be considered to increase or reduce the bitrate during the graphical presentation of the feature. For example, a user input device may be activated to expedite presentation of the feature, which in turn affects the bitrate at which the feature is compressed. In an embodiment where the EGM presents a slot machine style game, a feature may include one or more free spins that enable the user to stop the reels all at once if the spin or other user input device is activated similar to the embodiment described in relation to block 302. In such an embodiment, it may be desirable to change the bitrate from the bitrate that was previously sent to the compression module via the one or more bitrate controls to ensure that the immediate stoppage of the spinning reels is adequately presented without readily observable compression artifacts.

Similar to block 302, if it is determined at block 310 that the feature may be compressed according to one bitrate, block 314 (determines whether the presentation of the feature is complete) may return to block 312 (graphical data is compressed and sent for presentment to the user) instead of block 310 (sets the bitrate based on the one or more request criteria). This is intended to be a non-limiting embodiment of the disclosed system. For example, the feature may nevertheless be encoded at more than one bitrate if block 314 returns to block 312 instead of block 310 by implementing the methodologies already disclosed herein.

Following block 314 (determines whether the presentation of the feature is complete), or block 308 (determines whether a feature has been triggered) if no feature was triggered, it is determined at block 316 if a win animation is triggered. If a win animation is triggered, the game software may set one or more data compression settings of the compression module, such as bitrate, based on the one or more request criteria including, for example, the type of animation at block 318. In an embodiment where the EGM presents a slot machine style game, a win animation may be triggered any time a feature resulted in a prize for the user (which may be in addition to, if any, any celebratory graphics already presented to the user during the feature). A win animation may also be triggered anytime the original spinning of the reels resulted in a win for the user. A win animation may be directly dependent upon the amount won. For example, a win resulting in a payout that is more than ten or twenty times the wagered bet may cause a win animation of a particular degree worthy of notoriety. Such an animation increases the excitement for the user and allows the user to return to his family and friends with a story about the experience. A win animation of this degree may employ a high bitrate to minimize compression artifacts to ensure the utmost display quality. However, a win resulting in a less substantial payout, as compared to that described above, may include flashing the winning symbols and paylines. Such a win animation may employ a bitrate less than high for adequate presentment to the user.

Similarly, where the EGM presents a Roulette game, a win animation resulting from a simple black or red bet may employ low bitrate compression. However, a win resulting from a bet with a smaller chance of success may result in a more complex animation that employs a higher bitrate compression. As in other examples of bitrate control, a win animation may be compressed at more than one bitrate. For example, the beginning of a win animation may be compressed at a high bitrate, the middle at a lower bitrate, and the end at an even lower bitrate.

At block 320, the graphical data corresponding to the win animation is compressed according to the one or more bitrate control commands and is sent to the EGM for display and presentment to the user. It is then determined at block 322 if the presentation of the win animation is complete; and if not, block 318 is revisited. Revisiting block 318 until the presentation of the win animation is complete allows for the data to be compressed according to one or more bitrates.

In one embodiment, block 322 (determines whether the presentation of the win animation is complete) returns to block 318 (sets one or more data compression settings of the compression module based on the one or more request criteria) because factors other than the win animation, e.g., user inputs, may be considered to increase or reduce the bitrate during the graphical presentation of the win animation. For example, the user may desire to skip or otherwise expedite the presentation of a win animation to expedite game play. In one embodiment, the EGM enables the user to activate an input device, such as the bet or spin input, to skip or expedite presentation of the win animation. It may therefore be desirable to change the bitrate at which graphical data is compressed in view of the user's decision to be presented with a lesser quality animation or even a still representation of the animation. As such, the initial bitrate control command sent to the compression module may be superseded by one or more additional commands sent upon detection of the user input to reduce the bitrate, and therefore, the bandwidth consumed.

Similar to blocks 302 and 310, if it is determined at block 318 that the feature will be compressed according to one bitrate, block 322 (determines whether the presentation of the win animation is complete) may return to block 320 (presents win animation) instead of block 318 (sets one or more data compression settings of the compression module based on the one or more request criteria). This is intended to be a non-limiting, specific embodiment of the disclosed system. For example, the win animation may nevertheless be encoded at more than one bitrate if block 322 returns to block 320 instead of block 318 by implementing the methodologies already disclosed herein.

Following block 322 (determines whether the presentation of the win animation is complete), or block 316 (determines whether a win animation is triggered) if no win animation is triggered, the bitrate at which the compression module is to encode data may be set based on the one or more request criteria including, for example, predefined protocol at block 324. In one embodiment, the software, according to the predefined protocol, sends one or more bitrate control commands to the compression module to encode pursuant to a default bitrate until block 300 detects an input. For example, where there is no win animation (no win occurred) or after a win animation (win occurred), the game graphics may be idle or limited in complexity until block 300 detects a user input or autonomous software input. Inactive periods of time may occur, for example, where a user takes time to review the game outcome or decides to depart from the game device. Accordingly, in one embodiment, the default bitrate may be low without jeopardizing quality of service to prevent needless consumption of bandwidth. In an embodiment where a game server supports more than one EGM, such a reduction in bitrate during inactive or otherwise not graphically intensive periods of time may significantly reduce the overall bandwidth consumed by the bank of EGMs.

In other embodiments, however, there may be one or more default bitrates. This may occur, for example, where an EGM employs a default low bitrate for inactive periods and a higher default bitrate for graphical data complementing these inactive periods designed to entice a user to interact with the EGM. In one embodiment, the predefined protocol of block 324 may be based on the average number of inputs detected at block 300 over a period of time. In another embodiment, the predefined protocol of block 324 may be based on the average time between a win and the next user input. In another embodiment, the predefined protocol of block 324 may be based on the type of any graphical data displayed while the EGM is idle. In yet another embodiment, the predefined protocol of block 324 may be based on the available bandwidth.

In another embodiment, block 302 may also set one or more data compression settings of the compression module, such as bitrate based on the available bandwidth. For example, if a user or autonomous software input is detected at block 300, the game software may send one or more bitrate control commands to the compression module with instruction to compress data according to, for example, the input command, the type of graphical data, or the available bandwidth. Blocks 310 and 318 may similarly set one or more data compression settings of the compression module based on available bandwidth. In one embodiment, if the available bandwidth is of an amount that allows for the data to be encoded at a high bitrate, the data may be encoded at a high bitrate even though a lower bitrate is generally employed for adequate presentment to the user. In another embodiment, bandwidth may be deemed more important than the other factors for determining the bitrate at which to encode data. For example, if it is determined at block 310 that graphical data corresponding to the feature is to be encoded at a high bitrate, block 310 may further consider the available bandwidth. If the available bandwidth is insufficient for the feature to be encoded at a high bitrate, block 310 may operate to reduce the bitrate to an acceptable level in view of the available bandwidth. Such hierarchical operation may likewise apply to blocks 302 (sets one or more data compression settings of the compression module based on the one or more request criteria for game graphics), 318 (sets one or more data compression settings of the compression module based on the one or more request criteria for a win animation), and 324 (sets the bitrate at which the compression module encodes data at based on the one or more request criteria).

In one embodiment, the bitrate may be changed after the graphics are initially presented to the user at blocks 304, 312, and 320. For example, it may be determined that a feature warrants a high bitrate at block 310. However, the available bandwidth may drop after the initial determination is made. Accordingly, the software may send one or more bitrate control commands to the compression module to encode the remaining part of the feature at a lower bitrate in view of the available bandwidth.

In view of the embodiments and examples described herein, other embodiments employ hierarchical ranking separate from or in conjunction therewith. For example, data may be hierarchically ranked. In view thereof, the game software may set one or more data compression settings of the compression module, such as bitrate, based on the one or more request criteria including, for example, the rank corresponding to the data. Hierarchically ranked data may be ranked based on, for example, the one or more request criteria. In such an embodiment, the hierarchical rank may be controlling over the criteria used to rank the data itself. For example, two videos may both be graphically intensive and based on the same user input but nevertheless may be hierarchically-ranked differently. Thus, one may employ a higher compression bitrate over the other. A difference in hierarchical rank for the two videos may be justified where it is determined that although both are graphically intensive, encoding one at a lower bitrate does not result in as many readily observable compression artifacts as would the other. Hierarchically ranking data may also simplify the bitrate determination at blocks 302, 310, 318, and 324.

Those of ordinary skill will appreciate that the embodiments and examples disclosed herein enable real-time compression of data according to one or more bitrates via one or more bitrate control commands. Thus, the embodiments and examples herein may be implemented, where applicable, in such a way to enhance previous streaming techniques, such as adaptive streaming. For example, graphical data may be previously encoded at two different bitrates and indexed in memory. Per adaptive streaming, only the bitrates at which the data packets are indexed in memory are available for transfer to a client device based on a fluctuation of bandwidth and/or computing capacity. Thus, current adaptive streaming techniques may be enhanced with data encoded in real-time at bitrates different from that of the data packets indexed in memory based on available bandwidth, computing capacity, or the one or more request criteria.

In one embodiment, the one or more request criteria includes detection of a user input or software input, or the type of data involved. For example, where graphical data is previously encoded at a low bitrate and a high bitrate, adaptive streaming enables the server to automatically switch from the high bitrate data packets to the low bitrate data packets indexed in memory upon detecting a reduction in available bandwidth or the computing power of the client device. Thus, the system disclosed herein enables the previously encoded low and high bitrate data packets to be complemented by packets encoded at one or more bitrates, e.g., a medium bitrate, in real-time. In one embodiment, the switch between the indexed data packet and the data packet encoded in real-time may be performed as seamlessly as possible.

In one embodiment, the source data corresponding to the indexed data packets may be broken into similar discrete data segments. For example, where the source data is a movie and is previously encoded at a high and low bitrate, each indexed data packet of a low bitrate corresponds to the same segment of the movie of a data packet with a high bitrate to enable seamless transition between the two. To enable seamless transition between an indexed data packet and a data packet encoded in real-time, the movie may be segmented into chunks corresponding to the same time periods of the indexed data packets and stored in memory. Hash values may be used to keep track of which indexed data packet correlates to the corresponding segment of source data. Alternatively or additionally, multiple pointers based on time, for example, may be used to reference the locations in memory associated with the indexed data packet or segment of source data in line for transfer. It must be appreciated that the methodology for providing a seamless transition, or as close to seamless as possible, from an indexed packet to a packet that was encoded in real-time is intended as a non-limiting, specific embodiment of the system disclosed herein.

Accordingly, the embodiments and examples described herein may reduce the amount of memory consumed with respect to adaptive streaming; or at a minimum, reduce the number of previously encoded data packets that are indexed in memory. As previously indicated, adaptive streaming for graphical data such as a video is generally indexed at multiple bitrates in memory. In one embodiment, for example, a video indexed at five different bitrates may be reduced to two bitrates such as those that are most commonly required. If additional bitrates are desirable, the source data may be encoded in real-time at a bitrate different from the indexed data packets.

As previously indicated, FIG. 3 unveils a process for controlling the consumption of bandwidth with EGMs used as the educational avenue. EGMs are unique in that they are generally cyclical in nature as compared with other games (e.g., role-playing games, massively multiplayer online role-playing games, first person shooters, massively multiplayer online first person shooters, sport games, and the like), which tend to be more random. For example, where an EGM presents a slot machine style game, the game cycle is generally predictable in that the reels move vertically in each game cycle are usually surrounded by non-moving information such as credit meters or otherwise simple graphics. The predictability of game cycles, e.g., knowing that the reels are always spun along the same axis, lends itself very well to data compression. However, it is noted that the content displayed within each cycle is random to satisfy gaming regulations and player acceptance. In contrast to EGMs, other games such as massively multiplayer online role-playing games (MMORPGs) or first person shooters (FPS) on a console or computer are generally more random than cyclical due to the amount of control afforded to the player. For example, a player in an MMORPG controls a character avatar, commonly referred to as a toon, in a game world where the player may explore the game world, complete quests, interact with characters of other players or non-player characters (NPCs), and engage in combat against players or monsters. In FPS, a player controls a character but views the environment through the first person perspective of the character. Similar to MMORPG, a player navigates his character through a game world, interacting with the environment, and generally engages in combat against other players of a different faction or team. At any instantaneous point, a player may change the movement speed, direction, where the character is looking, or combinations thereof. As a result, these other games tend to lack the cyclical qualities from which EGMs stand to benefit. However, even games that seemingly lack cyclical qualities because they are laden with randomness resulting from the amount of control afforded to the player or actions taken by other players may use the bitrate control and management system, especially with the advent of cloud gaming.

Cloud gaming, also known as gaming on demand, is a gaming service offered by OnLive and other companies that enables a user to play a game without a console. From a hardware perspective and data flow perspective, FIG. 2 is representative of how cloud gaming works with at least one notable exception. Current cloud gaming technology does not send one or more bitrate commands from the game software to the compression module. Briefly explained, cloud gaming operates by a player submitting user inputs via a game controller to the game server. The game server in turn generates a graphical response based on the inputs generated by the player and other players (if a multiplayer game), compresses the graphical response, and sends it over a communication network to the player. The graphical response is then decompressed at the locale of the player and presented to the player via a display.

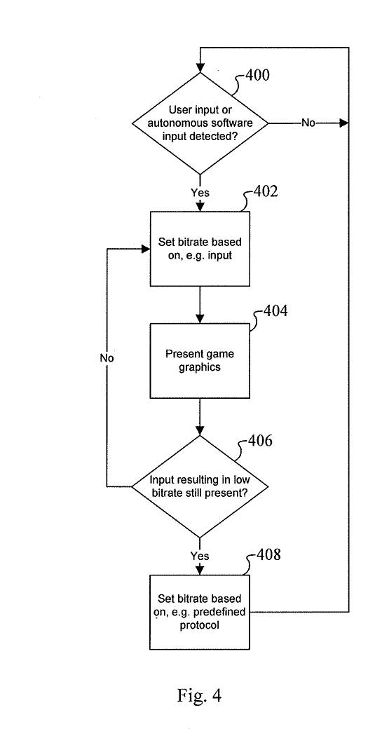

FIG. 4 is a logic flow diagram depicting a process for controlling the compression bitrate of data sent to a client device from a game server hosting a game that seemingly lacks cyclical qualities or is laden with randomness, such as role-playing or FPS games. The process depicted is intended to be a non-limiting, specific embodiment of the bitrate control and management system.

At block 400, a game server determines whether a user input or an autonomous software input has been detected. If neither is detected, the game software may wait until such an input is detected to send one or more bitrate control commands to the compression module. Otherwise, the compression module is, in one embodiment, set to encode at a predetermined or default bitrate until the game software provides instruction to decrease or increase it. Once either input is detected, block 402 may set one or more data compression settings of the compression module, such as bitrate, based on one or more request criteria including, for example, the input detected in block 400.

In one embodiment, the user input may constitute a means to decrease system latency and therefore reduce the amount of lag experienced by the player, e.g., any delay or latency associated with a player action and game reaction. For example, a user may initiate a decreased graphics mode, or hyper mode, where there is less lag because the compression/decompression is at a lower bitrate. Thus, the compression is quicker and results in less data to transfer over the communication network. In such a mode, the user is essentially accepting the inclusion of compression artifacts, e.g., pixilation of game play. Once the user sends the input to initiate hyper mode, the game software may send one or more bitrate request commands to the compression module to lower the bitrate.

In another embodiment, the game software may not only monitor for a user input such as the one for initiating hyper mode above, but also monitor the location of the player's character. Otherwise stated, the one or more request criteria may also include the location of the player's character. Accordingly, the game software may send one or more bitrate commands to the compression module based on the location of the player's character in the game world. The game world may vary in complexity from the simplest to the most complex. In one embodiment, the game software transmits one or more bitrate control commands instructing the compression module to encode game-related data at a default bitrate. In an embodiment where the bitrate has been numerically defined in the game software from 1 to 10, or lowest to highest, the default value may be 5 for most of the game world. However, simple areas within the game world may be encoded at a lower bitrate than 5 and the complex area may be encoded at a bitrate higher than 5. For example, once a character enters an area of simple complexity from a moderately complex area, the game software may send one more bitrate control commands to the compression module to reduce the bitrate from 5 until the character leaves the graphically simple area in the game world.

Additionally, locations that are graphically complex may nevertheless be controlled in a way similar to the above method, i.e., the bitrate may be reduced instead of increased upon the character entering such an area. For example, online role-playing games frequently have a city or town hall as a meeting place for players to cooperatively join in on quests with one another. The player may initiate a setting instructing the game software to lower the bitrate when the character is within the graphically complex area despite normally treating the area in such a way to raise the bitrate. Similar to hyper mode, these decreases in bitrate decrease system latency, and therefore, reduce the amount of lag experienced by the player. However, not only is the lag experienced by the player reduced, but the amount of bandwidth consumed is also reduced.

In yet another embodiment, the game software may reduce the bitrate at which the graphical data is encoded based on one or more request criteria including, for example, the inactivity of the player, e.g., where the player's character location has not changed over a period of time. Due to the inactivity of the player, the game software may set the bitrate below 5 even if the player is in a location typically calling for a bitrate higher than 5. Reducing the bitrate in such a way reduces the bandwidth consumed by the inactive player who has not exited the game world by, for example, logging out. This in turn introduces more bandwidth available for consumption by active players.

At block 404, the game graphics are presented to the user after decompression. It is then determined at block 406 if the input resulting in a bitrate increase or decrease is still present. If so, block 402 may be revisited; but if not, the game software may set one or more data compression settings of the compression module, such as bitrate, based on, for example, predefined protocol at block 408. In one embodiment, the game software may send one or more bitrate control commands to the compression module to encode pursuant to a high bitrate until block 400 detects an input. In another embodiment, the software may send one or more bitrate control commands to the compression module to encode pursuant to a low bitrate if it is determined, for example, that the player has engaged in network manipulation. In yet another embodiment, block 408 may set one or more data compression settings of the compression module, such as bitrate, based on one or more request criteria including, for example, the available bandwidth. As a result, a high bitrate may be employed if enough bandwidth is available to support it, or a lower bitrate may be employed if the available bandwidth is inadequate to support a higher bitrate. In yet another embodiment, block 408 may set the bitrate to a default value between 1 and 10.

Those of ordinary skill in the art will appreciate that the EGM, cloud gaming, and other gaming embodiments described herein are not intended to limit the bitrate control and management system disclosed herein; and will further realize that similar or other technologies in these or other industries stand to benefit from the bitrate control and management system. For example, streaming audio data over a communication network also consumes bandwidth, albeit generally not to the same extent that high quality graphical data does. Nevertheless, a reduction in bandwidth consumed by controlling the bitrate at which audio data is encoded prior to transmission over a communication network is discussed below.

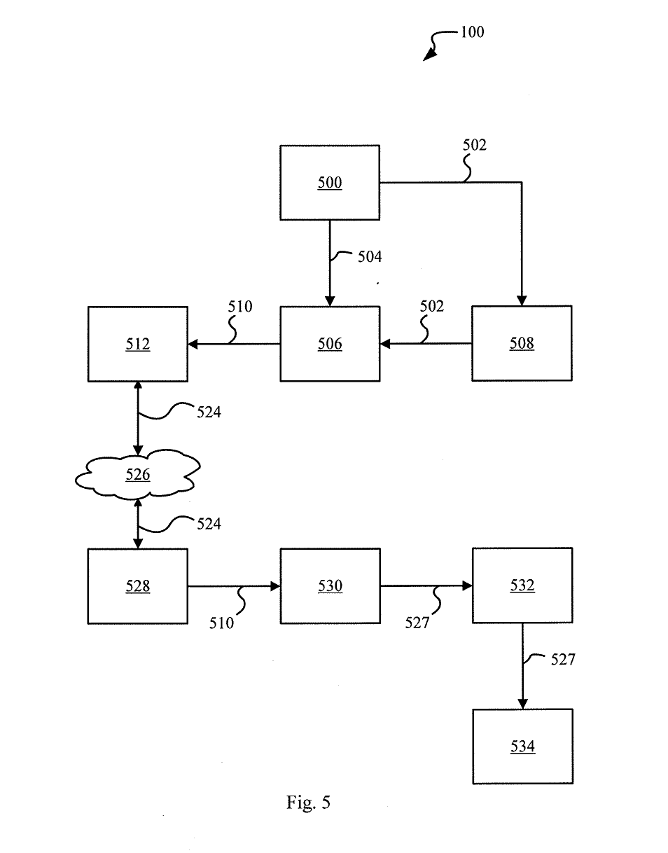

FIG. 5 is a block diagram illustrating an embodiment of a streaming bitrate control and management system that may transmit graphical data, audio data, or combinations thereof. In this embodiment, the streaming bitrate control and management system 100 includes a processor 500 that outputs audio data 502, and may send one or more bitrate control commands 504 to a compression module 506 to compress the audio data according to the bitrate associated with the one or more bitrate control commands. In one embodiment, compression module 506 utilizes the Advanced Audio Coding (AAC) codec. In some embodiments, the processor 500 may also generate graphical data such as that described herein. The one or more bitrate control commands 504 may also instruct the compression module to sample the audio data at a different rate such as 22 Hz rather than 44 Hz. From the processor 500, the audio data may be first transmitted, depending on the application, to a memory 508. Once the audio data is compressed according to the one or more bitrate control commands 504, the compression module 506 transmits the compressed data 510 to a first network interface 512 for transmission via transport protocol 524 over the communication network 526 to a second network interface 528. Upon receiving the compressed data 510 from the second network interface 528, the decompression module 530 decompresses the compressed audio data 510. In one embodiment, the decompressed data 527 is sent directly to a presentation system 534 including a speaker. In another embodiment, the decompressed data 527 may be sent to hardware 532 for storage in memory or further rendering prior to presentation to a user at the presentation system 534. In one embodiment, the presentation system 534 may present audio data, graphical data, or combinations thereof.

Thus, it must be appreciated that when audio data is transmitted over a communication network in conjunction with corresponding graphical data, the processor 500 may automatically reduce the bitrate at which the audio data is encoded if the compression module for the graphical data is instructed to reduce the compression bitrate. Similar to the graphical data of FIG. 2 and the process depicted in FIG. 3, the audio data may be compressed according to, for example, a user input, software input, game state, or the type of audio. For example, a transducer at an EGM may measure the environmental sound around it and send the resulting output to the server. If the surrounding environment exceeds a specified sound level, typically measured in decibels, a signal may be provided to the processor 500 over the communication network 526. The transducer signal may indicate that the quality at which the audio data is compressed may be reduced due to the user at the EGM being unable to fully appreciate the otherwise higher quality sound, which consumes more bandwidth, due to the noise surrounding the machine. Otherwise stated, the transducer enables a reduction or increase in sound quality in view of the environment surrounding the EGM.

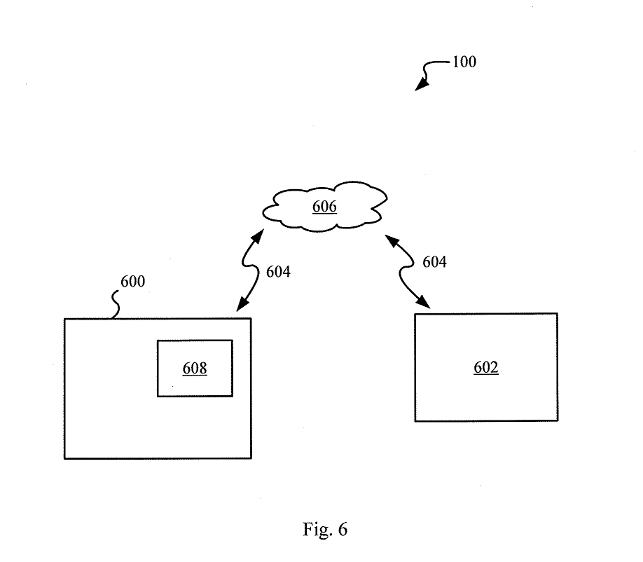

Referring now to FIG. 6, another embodiment of the bitrate control and management system 100 is shown. More specifically, a vehicle 600 configured to be in communication with a server 602 is shown. The vehicle 600 and server 602 are capable of transmitting and receiving data 604 over a communication network 606, which in this embodiment is wireless. For example, such a system may be capable of turn-by-turn navigation, hands-free calling, providing a driver or passenger with a menu to look up travel destinations such as restaurants and hotels, and vehicle security such as that offered by OnStar Corporation. However, the system 100 further enables a driver or passenger within the vehicle 600 to watch a streamed video with or without corresponding sound on a display 608 located within the vehicle such as in the headrest or dash. The video may be for entertainment, general communication, or for security, e.g., stream video of house surveillance cameras to vehicle for further monitoring. For example, a blockbuster movie may be streamed from the server 602 to the vehicle 600. As in yet another example, one within the vehicle may desire to participate in a video conference call. In any case, video streamed to the vehicle 600 from the server 602 may be compressed prior to transmission over the communication network 606 based on one or more bitrate control commands as described herein thus enabling control of the amount of bandwidth consumed.

Thus, those of ordinary skill in the art will appreciate that the bitrate control and management system reaches any industry utilizing wired or wireless communications to stream data from a transmitter (or transceiver) to a receiver (or transceiver). Accordingly, devices such as cell phones, smart phones, personal digital assistants (PDAs), computers, and portable media players may implement the bitrate control and management system disclosed herein. Data streaming systems in, for example, the medical industry, entertainment industry, broadcast industry, and educational services industry may also employ the bitrate control and management system. In one embodiment, the transmitter side disclosed herein may comprise the requisite receiver hardware. For example, video conferencing may entail two people in two different locales. Each locale may comprise transmission hardware and receiver hardware as described herein such that each system may transmit the corresponding video and audio to the other location and also receive the corresponding video and audio from the other location.

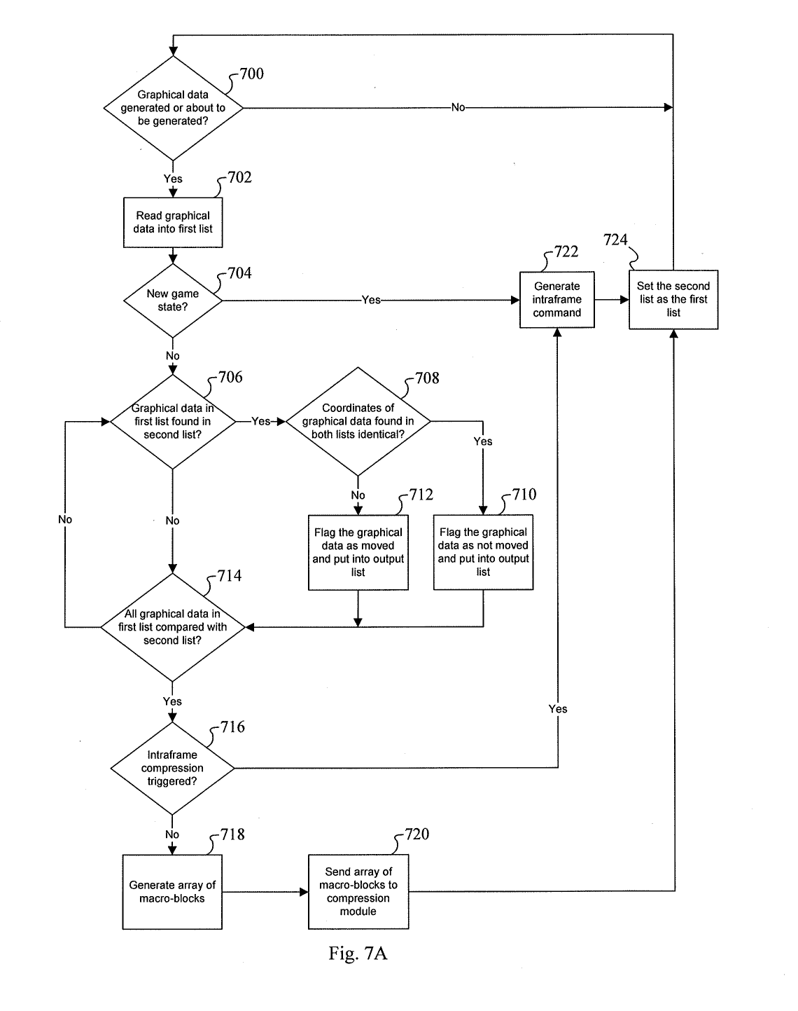

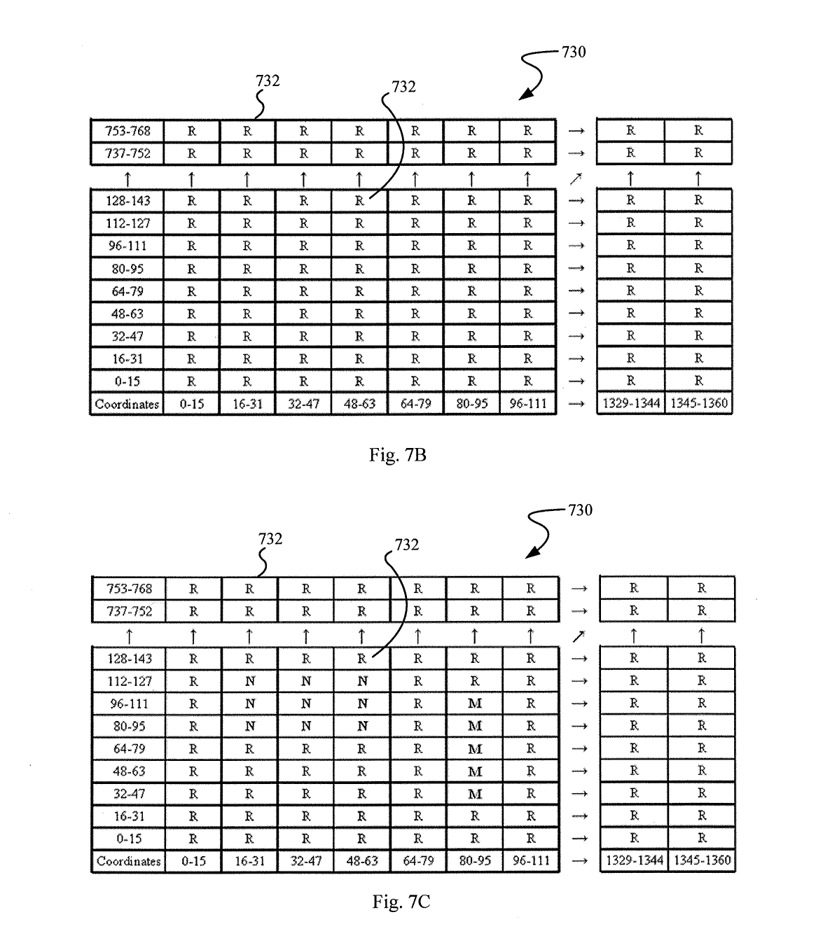

Referring now to FIG. 7A, a logic flow diagram depicts one embodiment of an interframe compression technique employed by the bitrate control and management system. More specifically, FIG. 7A depicts a motion compensation/estimation process for reducing the consumption of bandwidth and the workload of the compression module. Interframe compression techniques take into account at least one other frame to compress the current frame in view of the temporal redundancy associated with the current frame and the at least one other frame.

EGMs, such as the embodiment depicted in FIG. 2, will be used for explanatory purposes regarding the motion compensation/estimation methodology in view of the cyclical nature and the display of random graphical data in a predictable manner on such client devices. In other embodiments, applications that seemingly lack cyclical qualities because they are laden with randomness may use the bitrate control and management system. Those of ordinary skill in the art will further appreciate that other interframe compression techniques may be used in conjunction with, separate from, or alternatively to the motion compensation methodology described herein depending on the application. For example, a sub-sampling interframe compression technique may be used to also reduce (if used separately from or alternatively to the motion estimation technique) or further reduce (if used in conjunction with the motion estimation technique) the consumption of bandwidth and the workload of the compression module.

Referring now to the motion estimation process depicted in FIG. 7A, it may be implemented within the game software, for example, at or just above the graphics application programming interface (API) level. When the game software generates graphical data, an API such as OpenGL or DirectX may be used to interface with the graphics processor. However, other APIs may be used by the bitrate control and management system. Use of a scene graph API such as OpenSceneGraph may also be used to expedite the interframe compression technique described in FIG. 7A. In other embodiments, the motion estimation process may be employed without use of an API.

At block 700, the motion estimation process determines whether graphical data has been or is about to be generated by the game software. If not, the process revisits block 700. If so, block 700 proceeds to block 702 where the process reads the graphical data into a first (current frame) list. The graphical data is usually in the form of primitives such as bitmaps/textures and coordinates corresponding to the locations in which the primitives are to be represented in the frame buffer. After block 702, the process proceeds to block 704 where it is determined if the game is in the same state as the previous frame. For example, a previous and current frame may relate to a game state where the reel of a slot machine is spinning (same state); or the previous frame may relate to the reel spin, and the current frame may relate to a different state such as when a feature or win animation.

In one embodiment, the process may readily determine whether the game state has changed by monitoring a game state flag set by the game software when the game state has changed. In such an embodiment, the game state flag may be a binary bit that may be set as a 0 or a 1. A 1-bit binary scheme may be implemented to designate two distinct game states; or alternatively, may be implemented in such a way that a change from a 0 to a 1 or a 1 to a 0 indicates the game state has changed. Other embodiments may use more than one bit. For example, a 2-bit flag enables distinct recognition of four different states whereas a 3-bit flag enables distinct recognition of eight different game states. In some embodiments, the game software uses the game state flag to set the bitrate at which the compression module encodes data. For example, four different game state flags may correlate to four different bitrates. In another embodiment, the four flags may correlate to four different data compression settings of the compression module, which may or may not include bitrate.

If the game state has changed, the process proceeds from block 704 to block 722 where an instruction is sent to the compression module to generate an intraframe, i.e. compress the frame irrespective of the other frames. An intraframe is not dependent on another frame for the applied compression technique. However, an intraframe consumes more bandwidth than an interframe because more compressed data must be sent over the communication network as a result of the intraframe not benefiting from the relationship between any previous or future frame. Following block 722, the process proceeds to block 724 where the first (current frame) list is set as the second (previous frame) list and returns to block 700 to await the generation of new graphical data.

If the game state has not changed, block 704 proceeds to block 706 where it is determined whether the graphical primitives read into the first list are present in the second, previous frame list. In one embodiment, a hash value may be assigned to each graphical primitive along with the coordinates associated therewith to expedite the comparison of the graphical primitives in the first and second lists.

If a graphical primitive in the first list is found in the second list, it is determined at block 708 if the coordinates are the same for the graphical primitive found in each list. If the coordinates are the same, the process proceeds to block 710 where the graphical data is flagged as not having been moved and is put into an output list with data identifying it as such. For example, a moved/non-moved flag may be used. If the coordinates are not the same, the process proceeds to block 712 where the graphical data is flagged as having been moved and put into the output list with data identifying it as such. Both blocks 710 and 712 proceed to block 714 where it is determined if all graphical data in the first list has been compared to the graphical data in the second list. If not, block 714 returns to block 706 and the process continues until all the graphical data in the first list has been compared to the graphical data in the second list. If at block 714 it is determined that all of the graphical data has been compared against the graphical data in the second list, the process proceeds to block 716.

In one embodiment, block 716 may examine the number of graphical primitives present in the output list. If the output list is empty or contains a specified number of entries, then the process may instruct the compression module to compress the current frame as an intraframe and proceeds to block 722. In another embodiment, block 716 may examine the number of pixels corresponding to the graphical primitives in the output list. Based on the number of pixels, the process determines whether the graphical data corresponding to the frame analyzed should be compressed using an intraframe or interframe technique. In some embodiments, 100 pixels or fewer may be enough to trigger intraframe compression; whereas in other embodiments, 500,000 pixels may be considered too small to trigger intraframe compression. Where block 716 determines that intraframe compression is unwarranted or that interframe compression is desired, the process may proceed to block 718 to generate an array of macro-blocks that may be sent to the compression module at block 720. Those of ordinary skill in the art will appreciate that generation of the macro-block array may either supplement or supplant the motion compensation/estimation performed by the compression module. In either case, the processing time associated with the compression module is reduced as well as the amount of bandwidth consumed.

In generating the macro-block array at block 718, the process iterates through the output list flagging each macro-block that interacts, partly interacts, and does not interact with the graphical data therein with identification data. FIGS. 7B and 7C illustrate one embodiment of a frame divided into macro-blocks subjected to the process of block 718 (generates an array of macro-blocks). As shown in FIG. 7B, a portion of a frame 730 having an image resolution of 1360×768 has been divided into macro-blocks 732 having a resolution of 16×16. The image and macro-block resolutions are intended to be a non-limiting, specific embodiment. For example, the macro-blocks may have a resolution greater than or less than 16×16 in other embodiments. Prior to iterating through the output list, each macro-block 732 may be flagged with data identifying it as needing to be regenerated/recompressed by the compression module, designated in FIG. 7B as an R. Thus, in the embodiment shown, R is a default value for each macro-block prior to iteration through the output list. However, other embodiments may use one or more default values. For example, data corresponding to a particular set of macro-blocks may never change in some embodiments. As a result, it would be fruitless and a waste of system resources to first write data identifying those macro-blocks as needing to be recompressed when in fact a default value of R would always be overwritten once the output list is iterated through.

Referring now to FIG. 7C, the frame 730 is shown after the output list has been iterated through for each graphical primitive identified therein, but for illustrative purposes, only shows macro-blocks corresponding to two graphical primitives. The two graphical primitives are rectangles (one moved and one non-moved) encompassing the coordinates (8, 73) to (67, 135); and (74, 25) to (105, 115). As shown, the macro-blocks wholly within the rectangle are set either as an N, for non-moved, or M, for moved. Though not depicted, the macro-blocks identified with an M also have further identification data (i.e., a motion vector), indicating the position of the corresponding macro-block in the previous frame. For macro-blocks that the rectangles partly cover, the default value of R is left to ensure that any graphics that overlap are properly treated.

It may now be fully appreciated that as the number of macro-blocks that are identified as having been moved (M) or not moved (N) from the previous frame increase, a decrease in the amount of bandwidth consumed occurs because rather than compress the N and/or M macro-blocks, the compression module instead sends a signal to the decompression module on how to use the macro-blocks already received for the previous frame. As a result, less data is transferred over the communication network to the decompression module. This also increases the efficiency of the compression module.

As previously indicated, the bitrate control and management system enables control of the consumption of bandwidth by instructing the compression module to encode data at a particular bitrate in accordance with one or more bitrate control commands. Processes associated therewith also reduce the consumption of bandwidth and enhance the efficiency of the encoder by implementing motion compensation/estimation techniques for the compression module. However, the bitrate control and management system may nevertheless be implemented in a less desirable way, either advertently or inadvertently. For example and referring to FIG. 2, one may set the game software to generate one or more bitrate control commands associated with only high bitrates. Depending on the game designer, there may be little incentive to request lower bitrates when the game may be presented in a more visually stunning manner if only a high bitrate is used throughout all of the game content, e.g., win animations, feature animations, and other game animations or presentation of graphics. Thus, an instruction management system may be desirable in some embodiments to adjust the data compression setting request (e.g., bitrate request) sent to the compression module via the one or more bitrate control commands. In other embodiments, the instruction management system enables control of the bitrate at which legacy game content is encoded at. In one embodiment, legacy game content results from game software that is not programmed to include bitrate control requests (i.e., send one or more bitrate control commands to the compression module). In another embodiment, the instruction management system manages a plurality of bitrate control commands across a bank of EGMs.

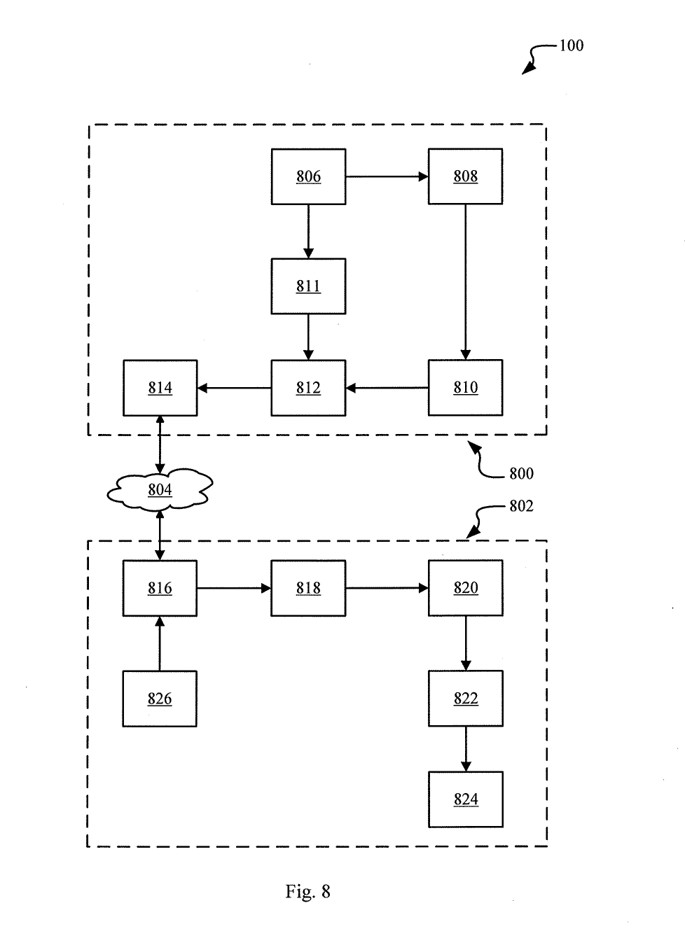

FIG. 8 is a block diagram illustrating an embodiment of a streaming bitrate control and management system including a game server, an EGM, and an instruction management module. In many respects, the bitrate control and management system 100 depicted in FIG. 8 is similar to the embodiment shown in FIG. 2. Thus, a game server 800, hosting the game software 806, is shown in communication with an EGM 802 over a communication network 804, which may be wired or wireless. In some embodiments, the game server 800 may support more than one EGM. The game server 800 further includes a graphics processor 808, a video memory 810, a compression module 812, and a network interface 814. Somewhat similar, the EGM 802 includes a network interface 816, a decompression module 818, a video memory 820, a video encoder 822, a display 824, and one or more user inputs 826. In some embodiments, EGM 802 may generate signals based on inputs irrespective of the user (e.g., the EGM may have at least one transducer or the like to send data relating to lighting, sound, or temperature conditions surrounding the EGM to the game server 800). These components of FIG. 8 operate like their respective components presented in FIG. 2. However, the server 800 in FIG. 8 further includes an instruction management system, depicted as instruction management module 811.

The instruction management module 811 may adjust the one or more instructions associated with the one or more bitrate control commands based on one or more management criteria including, for example, available bandwidth. In one embodiment, the instruction management module adjusts the data compression setting requests, e.g., bitrate requests, by altering the one or more bitrate control commands received from the game software 806. In another embodiment, the instruction management module adjusts the data compression setting requests (e.g., bitrate requests) by generating new bitrate control commands in place of the unaltered bitrate control commands received from the game software 806.

Although the process depicted in FIG. 3 discloses setting the bitrate based on the available bandwidth, the instruction management module 811 may either supplant or supplement such bitrate requests even though the game software has such control. In one embodiment, the instruction management module 811 supplants the bitrate requests generated by the game software 806 if the game software does not take into account the availability of bandwidth when generating the one or more bitrate control commands destined for the compression module 812. For example, if the game software 806 only generates high bitrate request signals and the instruction management module 811 determines that the bitrate request should be lower based on the available bandwidth, the instruction management module 811 may send one or more bitrate control commands to the compression module 812 for a lower bitrate than that which the game software 806 requested. In another embodiment, the instruction management module 811 may send one or more bitrate control commands to the compression module 812 for a higher bitrate than that which the game software 806 requested. For example, this may occur if the game software 806 sends a low bitrate request, but the instruction management module 811 determines that the available bandwidth allows for a higher bitrate.

In some embodiments, the one or more management criteria may include, for example, environmental data around the EGM 802 pertaining to information such as sound, lighting, and temperature conditions. Notably, the one or more management criteria may also include data corresponding to user inputs such as that generated by the one or more user inputs 826. In yet other embodiments, the one or more management criteria may include data corresponding to the average amount of money played at the machine; the average bet made by the user; the denomination of the machine; the average denomination of the machine; the current amount of credits available for play at the machine; the prestige of the user; or the type/amount of cashout (partial or full). In one embodiment, the one or more management criteria includes one or more of the criteria identified herein. Otherwise stated, the one or more management criteria may include one or more request criteria. In another embodiment, one or more request criteria may include one or more management criteria.

In other embodiments, the server 800 may host software for a plurality of EGMs 802. In such an embodiment, the one or more management criteria may include, for example, information related to which EGMs are making the bitrate requests. Additionally, EGMs may be hierarchically ranked either individually or in groups (and sub-groups) amongst the plurality. For example, in a plurality consisting of ten EGMs, the EGMs may be ranked one through ten. The ten EGMs may alternatively be ranked in groups (e.g., three may be ranked first, another three may be ranked second, and the remaining four may be ranked third). Thus, in one example, all ten EGMs may be in use and five of the ten machines may generate high bitrate requests at or around the same time for particular game content. However, the available bandwidth may only support three high bitrate requests and two low bitrate requests. Accordingly, the instruction management module 811 may, based on the one or more management criteria including hierarchical rank of the five EGMs, adjust the bitrate requests corresponding to the two lowest ranked machines amongst the five to a low bitrate while allowing the three higher ranked machines the higher bitrate actually requested.

Hierarchical ranking of a plurality of EGMs thus prevents, for example, the instruction management module 811 from being over-inclusive in its adjustment of bitrate requests. Absent the hierarchical rank in the example provided, the instruction management module 811 may reduce all the high bitrate requests associated with the five machines to low. In another embodiment, the instruction management module 811 may reduce the bitrate requests based on the one or more management criteria including, for example, the order of which the bitrate requests were received by the instruction management module.

In one embodiment, the hierarchical rank is determined in view of the one or more management criteria or the one or more request criteria, or combinations thereof. In another embodiment, hierarchical rank is set by the operator that may also be in combination with the one or more management or request criteria.

In embodiments where the game software, or other hardware in the system, does not generate bitrate control commands (bitrate requests), the instruction management module 811 may be used to interface with the user inputs and other game information relating to or generated by one or more EGMs. In such embodiments, the consumption of bandwidth corresponding to legacy games may be controlled via the instruction management module via one or more management criteria including, for example, user input data or autonomous software input data. Thus, if the user enters the spin command on an EGM presenting a slot machine style game, the instruction management module may receive the corresponding user input over the communication network. As a result, the instruction management module may set the bitrate associated with the spin data at the appropriate level, e.g., low, medium, or high.

Similarly, where the EGM is idle, e.g., where the game credits have reached zero, the instruction management module may react pursuant to this data by commanding the compression module to encode data being sent to the EGM from the game server at a lower bitrate in anticipation of the idle period that follows when a player leaves the EGM. Where game credits have been inserted, the instruction management module may correspondingly raise the bitrate associated with the compression module. In some embodiments, the instruction management module may further be configured to hierarchically rank user input or game related data among a single EGM or a plurality of EGMs. As a result, the consumption of bandwidth may be controlled in a hierarchical fashion even though one or more EGMs comprise legacy game content.

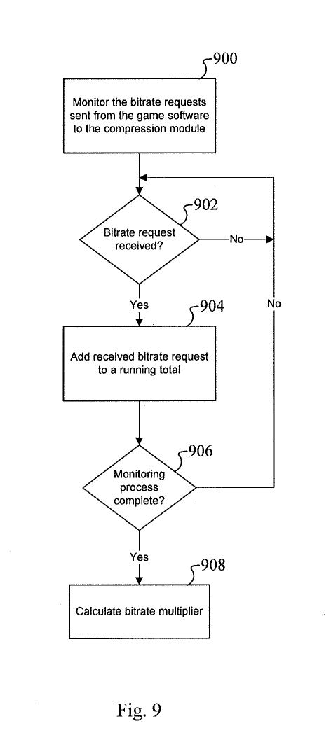

Referring now to FIG. 9, a logic flow diagram depicts one embodiment of a metering/monitoring process for determining the average bitrate requested by one or more EGMs, which is used to determine a bitrate request multiplier. The bitrate multiplier adjusts the bitrate requests destined to be received by the compression module to properly reflect the available bandwidth. At block 900, the instruction management module monitors the bitrate requests sent from the game software to the compression module corresponding to each EGM for a period of time. The period of time is preferably static but may be dynamic. For example, in one embodiment, the time period may be 24 hours, and in another embodiment, it may be 48 hours. In yet another embodiment, the time period may be 24 hours, but the time may only accrue when the EGM is actually in use such as when credits are actively being played on the machine.

In one embodiment, the metering process is performed during the initial testing of the one or more EGMs. In another embodiment, the process is performed during the initial deployment of the EGMs in the casino or other gaming establishment. Other embodiments periodically run this process after deployment to determine whether the average bitrate requested increases or decreases from the previously measured value; and recalculating the bitrate multiplier accordingly.

During the monitoring process, the instruction management module intercepts the bitrate requests sent from the game software. In one embodiment, the intercepted bitrate requests are not honored. However, in another embodiment, the intercepted bitrate requests are honored. In yet another embodiment, whether the intercepted bitrate request is honored during the monitoring process depends on the bitrate requested. In one embodiment, the bitrate requests range from 0.0, which is the lowest bitrate request, to 1.0, which is the highest bitrate request. In another embodiment, the bitrate requests range from 1 to 100 or from A to Z. The monitoring process may utilize each bitrate request received, or sample from the available bitrate requests at a particular rate.

Thus, it may determined at block 902 whether a bitrate request has been received, and if so, the process continues to block 904 to add the bitrate request to a running total. Following block 904, it is then determined at block 906 whether the metering process has run for the period of time previously determined. If not, the process revisits block 902 until the appropriate time period has elapsed. Once it is determined that the metering time period has elapsed, the process proceeds to block 908 to calculate the average bitrate request from the running total, which operates as the bitrate multiplier. For example, if bitrate requests are detected in even increments of 60 times a second and the metering process is 24 hours long, then this results in a total of 5,184,000 bitrate requests received. Assuming the first 12 hours of metering resulted in a non-fluctuating 0.2 bitrate request and the last 12 hours resulted in a non-fluctuating bitrate request of 0.6, the average would be (518,400+1,555,000)/5,184,000, which simplifies to (0.2+0.6)/2. Thus, the average bitrate multiplier is 0.4 in this example. A metering process returning a bitrate multiplier of 1.0 would mean that the game software only sent a request for the maximum bitrate.

Following the metering process depicted in FIG. 9, the bitrate multiplier may be used to allocate the maximum bandwidth corresponding to the metered EGM by dividing the allocated bandwidth by the bitrate multiplier to derive a maximum bandwidth. For example, assume that the EGMs metered in the examples above were allocated a bandwidth of 10 Mbits/s for game content. The EGM metering process resulting in a bitrate multiplier of 0.4 would provide a maximum bandwidth of 25 Mbits/s, whereas the process resulting in a bitrate multiplier of 1.0 would only provide a maximum bandwidth of 10 Mbits/s. Thus, those of ordinary skill in the art will appreciate that the EGM with the 0.4 bitrate multiplier will have significantly better peak quality than the EGM with the 1.0 bitrate multiplier, but both EGMs would use the same average bandwidth (10 Mbits/s). The bitrate multiplier thus encourages game designers to set correct bitrate control states in their software rather than simply encode all data at a high bitrate. Accordingly, EGMs enhanced by this disclosure may not only consume the same average bandwidth as EGMs that are not enhanced, but also present more visually stunning graphics. Additionally, the bitrate multiplier may be taken into consideration to fairly re-allocate bandwidth between a plurality of EGMs.

In one embodiment, the bitrate requests sent by the game software may be adjusted by the bitrate multiplier. For example, the instruction management module may, in view of the bitrate multiplier value, increase the bitrate at which particular game content is encoded despite the game software sending a command for a lower bitrate. Otherwise stated, the one or more management criteria may include, for example, the bitrate multiplier.

In some embodiments, the instruction management module 811 may receive data indicative of quality from the compression module 812. Utilizing the data in a feedback loop, the instruction management module 811 may then use this information to adjust the one or more data compression settings of the compression module until an acceptable error rate, i.e. quality, is achieved. For example, the instruction management module may increase or decrease the bitrate at which game data is encoded at until an acceptable error rate is achieved. In one embodiment, the compression module 812 calculates the error rate based on the peak signal-to-noise ratio (PSNR). In such a calculation, the signal is the original image, and the noise constitutes the differences, i.e. error, introduced by the compression. A low PSNR value indicates low quality (high error rate) whereas a high PSNR value indicates high quality (low error rate). Thus, the instruction management module 811 may calculate an average PSNR over a period of time and adjust the bitrate the compression module encodes at accordingly. Otherwise stated, the management criteria may include PSNR. In some embodiments, the instruction management module 811 receives the error rate produced by the compression module 812 as well as data corresponding to user inputs or other game information. Accordingly, an acceptable error rate may vary depending on the data received from the EGM. For example, a high error rate may be deemed acceptable when the credits have reached zero.

In view of the foregoing, those of ordinary skill in the art will appreciate that any modules disclosed herein may be integrated into a single processor or be a separate, distinct hardware unit. For example, the processor running the game software in FIGS. 2 and 8 may also comprise the instruction management module. As yet another example, the memory associated with the graphics processor may be separate from the graphics processor. In another example, the memory may be integrated into the graphics processor. Furthermore, the one or more bitrate control commands have generally been disclosed as low, high, or possessing some other value. Those of ordinary skill in the art will appreciate that in an embodiment where the bitrate request may vary from 0.0 to 1.0, a high bitrate may be greater than or equal to 0.5, and a low bitrate would be less than 0.5. In other embodiments, a high bitrate may be greater than or equal to 0.8 and a low bitrate would be less than 0.8. In another embodiment, a high bitrate may be considered high if the request is greater than or equal to 0.3. In yet another embodiment, the bitrate request may vary from 0 to 1000. Thus, the values discussed herein are relative, e.g., high is higher than low, and are intended as non-limiting, specific embodiments of the bitrate control and management system.

Those of ordinary skill in the art will also appreciate that the one or more bitrate control commands and the instruction management module disclosed herein may effectuate changes that affect bitrate but that do not per se control bitrate. For example, in some embodiments, the one or more bitrate control commands and instruction management module may vary the frame size from the original size. In embodiments where motion compensation/estimation is left for the compression module, the one or more bitrate control commands and instruction management module may vary the search shape and size. Thus, as indicated herein, one or more data compression settings of the compression module other than bitrate may also be controlled. For example, in an embodiment employing the H.264 codec, the entropy encoding mode may be controlled.

Those of ordinary skill in the art will further appreciate that the bitrate control and management system 100 disclosed herein may be complemented by the teachings disclosed in commonly owned U.S. patent application Ser. No. ______, entitled Graphics Processing Unit Memory Usage Reduction. More specifically, some embodiments of the bitrate control and management system 100 may implement one or more teachings of U.S. patent application Ser. No. ______ to reduce the graphical footprint of the memory associated with the graphics processor. In some embodiments, for example, the memory associated with the graphics processor may store uncompressed textures. In other embodiments, the memory associated with the graphics processor may store compressed textures. In yet other embodiments, the memory associated with the graphics processor may store a combination of compressed and uncompressed textures. In such embodiments, the graphics processor may decompress the compressed textures prior to rendering the frame calling for the compressed textures. Accordingly, U.S. patent application Ser. No. ______, entitled Graphics Processing Unit Memory Usage Reduction, is incorporated by reference in its entirety and is filed concurrently herewith.

The various embodiments and examples described above are provided by way of illustration only and should not be construed to limit the claimed invention, nor the scope of the various embodiments and examples. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A bitrate control and management system comprising:
a server including a first processor that outputs data, a second processor that renders the data output by the first processor and outputs rendered data, and a compression module that encodes the rendered data and outputs encoded data; and
a client device in communication with the server over a network having a bandwidth, wherein the server transmits the encoded data to the client device, the client device including a decompression module that receives and decodes the encoded data received from the server, and one or more user input devices that generate user input data receivable by the server;
wherein the first processor sends one or more bitrate control commands based on one or more request criteria to the compression module, wherein the compression module receives the one or more bitrate control commands and encodes the rendered data according to the one or more bitrate control commands.

2. The system of claim 1, wherein the one or more request criteria includes the data output by the first processor.

3. The system of claim 1, wherein the one or more request criteria includes bandwidth.

4. The system of claim 1, wherein the one or more request criteria includes data generated by the client device.

5. The system of claim 4, wherein the data generated by the client device is the user input data.

6. The system of claim 1, wherein the data output by the first processor is hierarchically ranked and the one or more request criteria includes the hierarchical rank.

7. The system of claim 1, wherein the data output by the first processor is graphical data.

8. The system of claim 1, wherein the data output by the first processor is audio data.

9. The system of claim 1, wherein the first processor performs a motion compensation process for the compression module to reduce workload of the compression module or increase availability of the bandwidth of the network.

10. The system of claim 9, wherein the motion compensation process results in the first processor outputting motion compensation data to the compression module.

11. The system of claim 10, wherein the motion compensation data identifies data output by the first processor that was previously encoded and sent to the client device.

12. The system of claim 1, wherein the client device further includes a display.

13. The system of claim 12, wherein the client device further includes a video encoder that encodes the decoded data into a display signal compatible with the display.

14. The system of claim 13, wherein the data output by the first processor is destined for a gaming establishment.

15. The system of claim 13, wherein the client device is an electronic gaming machine.

16. The system of claim 1, further comprising an instruction management module.

17. The system of claim 16, wherein the instruction management module intercepts the one or more bitrate control commands destined for the compression module.

18. The system of claim 17, wherein the instruction management module adjusts the one or more bitrate control commands based on one or more management criteria.

19. The system of claim 18, wherein the one or more management criteria includes the data output by the first processor.

20. The system of claim 18, wherein the one or more management criteria includes bandwidth.

21. The system of claim 18, wherein the one or more management criteria includes data generated by the client device.

22. The system of claim 21, wherein the data generated by the client device is the user input data.

23. The system of claim 18, wherein the one or more management criteria is different than the one or more request criteria.

24. The system of claim 18, wherein the client device is hierarchically ranked amongst a plurality of client devices, and the one or more management criteria includes the hierarchical rank.

25. The system of claim 18, wherein the instruction management module adjusts the one or more bitrate control commands intercepted by altering the one or more bitrate control commands intercepted.

26. The system of claim 18, wherein the instruction management module adjusts the one or more bitrate control commands intercepted by generating new one or more bitrate control commands.

27. The system of claim 25, wherein the data output by the first processor is destined for a gaming establishment.

28. The system of claim 26, wherein the client device is an electronic gaming machine.

29. The system of claim 17, wherein the instruction management module determines average bitrate requested by the first processor over a period of time.

30. The system of claim 28, wherein the instruction management module adjusts the one or more bitrate control commands based on the average bitrate.

31. The system of claim 16, wherein the compression module is configured to generate data indicative of compression quality produced by the compression module.

32. The system of claim 31, wherein the instruction management module sends one or more bitrate control commands to the compression module based on the data indicative of compression quality.

33. A bitrate control and management system comprising:
a server including a first processor that outputs data in communication with a compression module having one or more data compression settings, wherein the first processor sends one or more bitrate control commands to the compression module that modifies the one or more data compression settings of the compression module; and
a client device in communication with the server over a network having a bandwidth, wherein the client device receives data from the server and includes a decompression module that receives and decodes the data received from the server, and one or more user input devices that generate user input data receivable by the server.

34. The system of claim 33, wherein the one or more bitrate control commands are based on one or more request criteria.

35. The system of claim 34, wherein the one or more request criteria includes the data output by the first processor.

36. The system of claim 34, wherein the one or more request criteria includes bandwidth.

37. The system of claim 34, wherein the one or more request criteria includes data generated by the client device.

38. The system of claim 37, wherein the data generated by the client device is the user input data.

39. The system of claim 34, wherein the data output by the first processor is hierarchically ranked and the one or more request criteria includes the hierarchical rank.

40. A bitrate control and management system comprising:
a server including a first processor that outputs data, a second processor that renders the data output by the first processor and outputs rendered data, and a compression module having one or more data compression settings that encodes the rendered data and outputs encoded data;
a client device in communication with the server over a network having a bandwidth, wherein the server transmits the encoded data to the client device, the client device including a decompression module that receives and decodes the encoded data received from the server, and one or more user input devices that generate user input data receivable by the server; and
an instruction management module that modifies the one or more data compression settings of the compression module.

41. The system of claim 40, wherein the compression module is configured to generate data indicative of compression quality produced by the compression module.

42. The system of claim 41, wherein the instruction management module sends one or more bitrate control commands to the compression module based on the data indicative of compression quality.

43. The system of claim 40, wherein the instruction management module receives data generated by the client device relating to the data generated by the server.

44. The system of claim 43, wherein the data generated by the client device is user input data.

45. A method for controlling the amount of bandwidth consumed in a system involving a server streaming data to a client device over a communication network, the method comprising:
generating data at the server using a first processor;
rendering the data generated by the first processor at the server using a second processor;
generating one or more bitrate control commands at the server based on one or more request criteria;
encoding the rendered data pursuant to the one or more bitrate control commands using a compression module; and
transmitting the encoded data to the client device over the communication network.

46. The method of claim 45, wherein generating the one or more bitrate control commands is performed by the first processor at the server.

47. The system of claim 46, wherein the one or more request criteria includes the data generated by the first processor.

48. The system of claim 46, wherein the one or more request criteria includes bandwidth.

49. The system of claim 46, wherein the one or more request criteria includes data generated by the client device.

50. The system of claim 49, wherein the data generated by the client device is user input data.

51. The system of claim 46, wherein the data generated by the first processor is hierarchically ranked and the one or more request criteria includes the hierarchical rank.

52. The method of claim 45, wherein generating the one or more bitrate control commands is performed by an instruction management module that receives data generated by the client device.

53. The method of claim 45, further comprising performing a motion compensation process for the compression module to reduce workload of the compression module and increase availability of the bandwidth of the communication network.

54. The method of claim 53, further comprising generating motion compensation data using the first processor.

55. The method of claim 54, further comprising sending the motion compensation data to the compression module.

56. The method of claim 45, further comprising intercepting the one or more bitrate control commands prior to receipt by the compression module using an instruction management module.

57. The method of claim 56, further comprising sending the one or more bitrate control commands to the compression module.

58. The method of claim 57, further comprising adjusting the one or more bitrate control commands based on one or more management criteria.

59. The method of claim 58, further comprising sending the adjusted one or more bitrate control commands to the compression module.

60. A method for controlling the amount of bandwidth consumed in a system involving a server streaming data to a client device over a communication network, the method comprising:
generating data at the server using a first processor;
encoding the data generated by the first processor using a compression module having one or more data compression settings;
generating data indicative of quality of the encoded data using the compression module;
receiving the data indicative of quality by an instruction management module; and
transmitting the encoded data to the client device over the communication network.

61. The method of claim 60, further comprising sending one or more bitrate control commands to the compression module based on the data indicative of quality.

62. The method of claim 61, wherein the one or more bitrate control commands modifies the one or more data compression settings of the compression module.

63. The method of claim 62, further comprising rendering the data generated by the first processor by a second processor prior to encoding.

64. A method for controlling the amount of bandwidth consumed in a system involving a server streaming data to a client device over a communication network, the method comprising:
generating data at the client device, wherein the client device has one or more user input devices;
transmitting the generated data over the communication network to the server having a compression module, wherein the compression module has one or more data compression settings;
receiving the transmitted data at the server, wherein the server has an instruction management module to analyze the data generated at the client device; and
generating one or more bitrate control commands based on the data generated at the client device, wherein the one or more bitrate control commands modifies the one or more data compression settings of the compression module.

65. The method of claim 64, further comprising generating data at the server.

66. The method of claim 65, further comprising encoding the data generated at the server pursuant to the one or more bitrate control commands.

67. The method of claim 64, further comprising transmitting the encoded data to the client device over the communication network.
